(19) United States
(12) Patent Application Publication
(10) Pub. No.: US 2015/0281526 A1
(43) Pub. Date: Oct. 1, 2015

(54) SENSOR COVER

(71) Applicant: VISION IO AS, Sandnes (NO)

(72) Inventors: Øyvind Hovland, Royneberg (NO); André Hognestad, Randaberg (NO)

(21) Appl. No.: 14/440,261

(22) PCT Filed: Oct. 31, 2013
(86) PCT No.: PCT/EP2013/072787

§ 371 Date: May 1, 2015

(30) Foreign Application Priority Data
Nov. 1, 2012 (NO) 20121288

(51) Int. Cl. H04N 5/225; H04N 7/18; G06T 7/00; E21B 47/12; E21B 47/01

(52) U.S. Cl. CPC H04N 5/2252; E21B 47/12; E21B 47/011; G06T 7/0012; H04N 7/18

(57) ABSTRACT

A sensor cover (24) for an inspection assembly. The inspection assembly is adapted to inspect the interior of a hollow member (22). The hollow member is at least partially filled with a hollow member fluid. The hollow member comprises a hollow member wall (26) defining a hollow member duct. The sensor cover comprises connection means (30) for connection to a sensor (12) of the inspection assembly to thereby cover at least a portion of the sensor. The sensor is adapted to receive a sensor signal and the sensor cover being adapted to transmit the sensor signal. The sensor cover is sized and configured to, at least during a sensor operation procedure, be accommodated in the hollow member. The sensor cover is adapted to constitute a hollow member fluid displacement means adapted to take the place of a portion of the hollow member fluid to thereby enable the sensor signal to be transmitted from the hollow member wall to the sensor.

### TECHNICAL FIELD

The present disclosure relates to a sensor cover according to the preamble of claim 1. Moreover, the present disclosure relates to a kit and an inspection assembly, respectively. Furthermore, the present disclosure relates to a method for forming an inspection assembly and a method for inspecting the interior of a hollow member, respectively.

### BACKGROUND

In the drilling and production of oil and gas wells, it is often necessary to obtain the inner surface information concerning conditions within the borehole. For example, tools and other objects may become lodged in the borehole during the drilling of a well. Such objects must be retrieved before drilling can continue.

In the operation and/or periodic maintenance of producing or injection wells, it is frequently necessary to obtain information about the construction and/or operating condition of production equipment located downhole. For example, detection of the onset of corrosion damage to well tubing or casing within a borehole enables the application of anti-corrosive treatments to the well. Early treatment of corrosive well conditions prevents the highly expensive and dangerous replacement of corrosion damaged well production components.

Other maintenance operations in a production well environment, such as replacement of various flow control valves or the inspection of the location and condition of casing perforations, make it highly desirable for an operator located at the surface to obtain accurate, real-time information about so downhole conditions.

In fact, new regulations require operators of oilfields to perform a visual inspection of their safety/barrier valves after certain operations to verify cleanness to secure a further safe operation. These are often referred to as BlowOut

Preventers (BOP) which are a large, specialized valves or similar mechanical device, usually installed redundantly in stacks, used to seal, control and monitor oil and gas wells, and intended to prevent tubing (e.g. drill pipe and well casing), tools and drilling fluid from being blown out of the wellbore (also known as bore hole, the hole leading to the reservoir) when a blowout threatens.

Preferable, the above-mentioned inspection should be executed with an image sensor while the BOP is in position on the seabed. The main challenge preventing this is the contaminated fluid at the point of interest. Quite often expensive drilling rigs unsuccessfully try to displace the contaminated water with clean water to achieve images of subsea equipment. The water remains too contaminated to achieve quality images, and the consequence is that the BOP needs to be pulled to surface to be visually inspected onboard the rig and rerun thereafter. This operation involves several heavy lifts and is very time demanding; several days of lost operation.

Other tubulars may need inspection. This is the case of risers, large tubulars connecting Oil and Gas exploration or production platforms or ships to subsea installations.

Various techniques have been proposed for obtaining at the surface information about the conditions within a borehole, well, pipe or other tubular constructions filled with contaminated fluid with and image sensor/camera. One example is disclosed in US patent U.S. Pat. No. 4,938,060, to Halliburton (ex-OTIS), inv Sizer et al. It includes a method of injecting coiled tubing having an inspection sensor into a wellbore to a selected location, injecting an optically transparent or acoustically so homogenous fluid into the wellbore through the coiled tubing to form a slug of such fluid around the sensor, and transmitting signals from the sensor representative of well conditions to the surface. The method may be practiced to inspect only the region around the sensor at a selected depth in the well or may so be continuously practiced to examine the length of the wellbore by producing the well and retrieving the coiled tubing and sensor at a controlled rate synchronized with the rate of well production.

The problem with U.S. Pat. No. 4,938,060 is that it only provides pointwise transparency between the image sensor and the object of interest. The effect is also time limited since the optical transparent fluid is ejected into the contaminated fluid, so that the situation of opacity around the image sensor will shortly return.

It is therefore a need in inspection systems of tubular constructions filled with contaminated fluid for a device improving signal transfer between the image sensor and the so surface to be inspected.

### SUMMARY

One object of the disclosure is to reduce or ameliorate at least one of the disadvantages of the prior art systems and/or methods, or to provide a useful alternative.

This object is achieved by a sensor cover according to claim 1.

As such, the present disclosure relates to a sensor cover for an inspection assembly. The inspection assembly is adapted to inspect the interior of a hollow member. The hollow member is at least partially filled with a hollow member fluid. The hollow member comprises a hollow member wall defining a hollow member duct. The sensor cover comprises connection means for connection to a sensor of the inspection assembly to thereby cover at least a portion of the sensor. The sensor is adapted to receive a sensor signal and the sensor cover is adapted to transmit the sensor signal. The sensor cover is sized and configured to, at least during a sensor operation procedure, be accommodated in the hollow member.

The sensor cover constitutes a fluid displacement means adapted to take the place of a portion of said hollow member fluid to thereby enable the sensor signal to be transmitted from the hollow member so wall to the sensor.

As such, by virtue of the fact that the sensor cover takes the place of the hollow member fluid, a sufficiently small gap between the sensor cover and the hollow member wall may be obtained.

Consequently, the presence of the sensor cover implies in that only a relatively small amount of fluid, which fluid may have poor or inferior sensor signal transmitting properties, is present between the sensor cover and the hollow member wall. This in turn implies that the sensor may receive appropriate signals from the hollow member wall.

Optionally, the hollow member has a hollow member cross section area. The sensor cover comprises a largest sensor cover cross section area. The largest sensor cover cross section area is at least 60%, preferably at least 80%, of the hollow member cross section area.

Optionally, the sensor cover comprises a sensor cover wall at least partially enclosing a sensor cover volume. The sensor cover further comprises a sensor cover fluid accommodated within the sensor cover volume.

Optionally, the sensor cover fluid is optically and/or acoustically transparent. Optionally, the above discussed sensor cover wall is also optically and/or acoustically transparent.

Optionally, the sensor cover fluid is a liquid.

Optionally, the sensor cover comprises a cylindrical sensor cover portion with a substantially circular cross section.

Optionally, the cylindrical sensor cover portion has a cylindrical sensor cover portion diameter and a cylindrical sensor cover portion length. The cylindrical sensor cover portion length is at least 0.3 times, preferably at least 0.5 times, the cylindrical sensor cover portion diameter.

The above discussed cylindrical sensor cover portion implies that a sensor may have a relatively large sensor field with an appropriately small gap between the sensor cover and the hollow member wall. For instance, if the sensor comprises a camera, the camera may obtain a relatively large field of vision, with an appropriately low amount of obscurity, of the hollow member wall.

Optionally, at least a portion of the sensor cover is dome shaped. As used herein, the expression “dome” encompasses any shape that is a portion of a sphere. Purely by way of example, a “dome” may preferably have the shape of approximately half of a sphere.

Optionally, at least a portion of said sensor cover is made of an acrylic material or a sapphire crystal.

In an embodiment of the sensor cover that comprises a sensor cover wall, the sensor cover wall may optionally be made of an acrylic material or a sapphire crystal.

A second aspect of the present disclosure relates to a kit for an inspection assembly for inspecting the interior of a hollow member. The kit comprises an inspection sensor adapted to receive a sensor signal and a sensor cover according the first aspect of the present disclosure.

Optionally, the kit comprises a plurality of sensor covers.

Optionally, at least two of the sensor covers have different radial sizes.

A third aspect of the present disclosure relates to an inspection assembly for inspecting the interior of a hollow member. The inspection assembly comprises an inspection sensor adapted to receive a sensor signal and a sensor cover according to the first aspect of the present disclosure.

A fourth aspect of the present disclosure relates to a method for forming an inspection assembly for inspecting the interior of a hollow member. The hollow member is at least partially filled with a hollow member fluid. The hollow member comprising a hollow member wall defining a hollow member duct. The method comprising:
determining the size of the hollow member duct;
determining an inspection sensor adapted to receive a sensor signal, and
determining an sensor cover adapted to transmit the sensor signal, the sensor cover being adapted to, at least during a sensor operation procedure, be accommodated in the hollow member, the size of the sensor cover being such that, during the sensor operation procedure, the sensor cover takes the place of a portion of the hollow member fluid to thereby enable that the sensor signal can be transmitted from the hollow member wall to the sensor.

Optionally, the hollow member has a hollow member cross section area. The method further comprising:
selecting the sensor cover such that the sensor cover comprises a largest sensor cover cross section area, the largest sensor cover cross section area being at least 60%, preferably at least 80%, of the hollow member cross section area.

A fifth aspect of the present disclosure relates to a method for inspecting the interior of a hollow member. The hollow member is at least partially filled with a hollow member fluid. The hollow member comprising a hollow member wall defining a hollow member duct. The method comprising:
determining the size of the hollow member duct;
selecting an inspection assembly which comprises an inspection sensor and a sensor cover such that the sensor cover at least partially covers the sensor, the sensor being adapted to receive a sensor signal and the sensor cover being adapted to transmit the sensor signal, the sensor cover being adapted to, at least during a sensor operation procedure, be accommodated in the hollow member portion, the size of the sensor cover being such that, when the sensor cover is accommodated in the hollow member, the sensor cover takes the place of a portion of said hollow member fluid to thereby enable that the sensor signal can be transmitted from the hollow member wall to the sensor, and
arranging the inspection assembly into the hollow member.

Optionally, the method further comprises forming an inspection assembly by connecting together the inspection sensor and the sensor cover such that the sensor cover at least partially covers the sensor.

Optionally, the hollow member comprises a hollow member portion with a hollow member cross section area. The method further comprising:
selecting the sensor cover such that the sensor cover comprises a largest sensor cover cross section area, the largest sensor cover cross section area being at least 60%, preferably at least 80%, of the hollow member cross section area.

The embodiments herein are not limited to the features and advantages mentioned above. A person skilled in the art will recognize additional features and advantages upon reading the following detailed description.

### FIGURES

FIG. 1 illustrates an example of an inspection camera for fluid filled pipes according to state of the art,

FIG. 2 illustrates an example of an inspection camera for fluid filled pipes according the present invention.

### DETAILED DESCRIPTION

In the following, the embodiments herein will be discussed and example embodiments described by referring to the accompanying drawings.

The invention relates to a device for inspection of all kinds of fluid filled tubular; pipes, oil- and gas wells and production- and workover risers, BOPs etc., where visual camera inspections are being performed to enhance image quality during visual camera inspection, more particularly, to a device for enabling an unobstructed optical or acoustic inspection of physical conditions within a borehole. The invention may be practiced e.g. during maintenance and servicing of oil, gas, geothermal, and injection wells.

Several inspection assemblies for tubular devices like pipes, oil- and gas wells and production- and workover risers, BOPs etc. which includes cameras or other forms of image sensors are known. In a typical arrangement, a probe connected to a wire is lowered into the pipe to be inspected by means of a motorized winch. For visual inspection, the probe could be a shielded camera transmitting captured images through a cable which could run through, be a part of or constitute the wire. The movements of the probe and the camera itself, is controlled by an operator onshore or at a rig through a user interface which also displays the images captured by the camera. Such an arrangement allows for inspection of the inner surface of the pipes and wells, as well as risers, valves and BOPs. For the purpose of simplicity, all kinds of tubular devices and arrangements like pipes, oil- and gas wells and production- and workover risers, BOPs etc. are referred to as pipes in the following description.

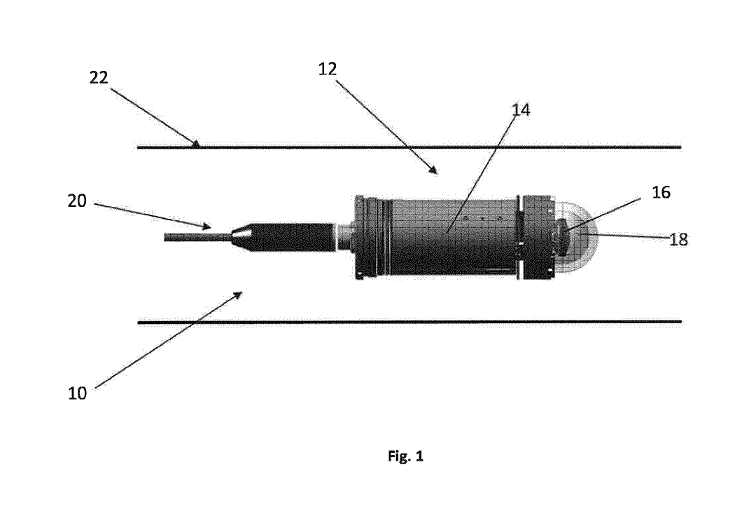

FIG. 1 illustrates an example of an inspection assembly 10. The inspection assembly 10 in this example consists of a sensor 12, which in FIG. 1 is exemplified as a camera socket 14, a camera lens 16 and a lens capsule 18. Moreover, the inspection assembly 10 comprises an optical cable 20 connected to the sensor 12. In addition, there is a light source (not shown) provided to illuminate the camera's area of view.

Moreover, FIG. 1 illustrates a portion of a hollow member 22, which in FIG. 1 is exemplified as a pipe.

The camera socket typically includes hardware for sensing and processing images enclosed by a shield adjusted to protect the hardware from e.g. friction, impacts and pressure differences while running through the pipe. The camera lens may preferably be protected by a transparent lens capsule.

However, camera lenses are relatively small compared to the inner diameter of the tubular of inspection. Operating pipes and wells are usually filled with opaque fluid, making it difficult to capture images, resulting in degrading the images captured by the camera. Due to the presence of contaminated fluid, the amount of light reflecting particles in the water prevents quality images being taken and impedes visual so inspection light. Decentralization of the camera brings it closer to one side, but still a required 360 degrees visual coverage in the cross section plane of the pipe is impossible.

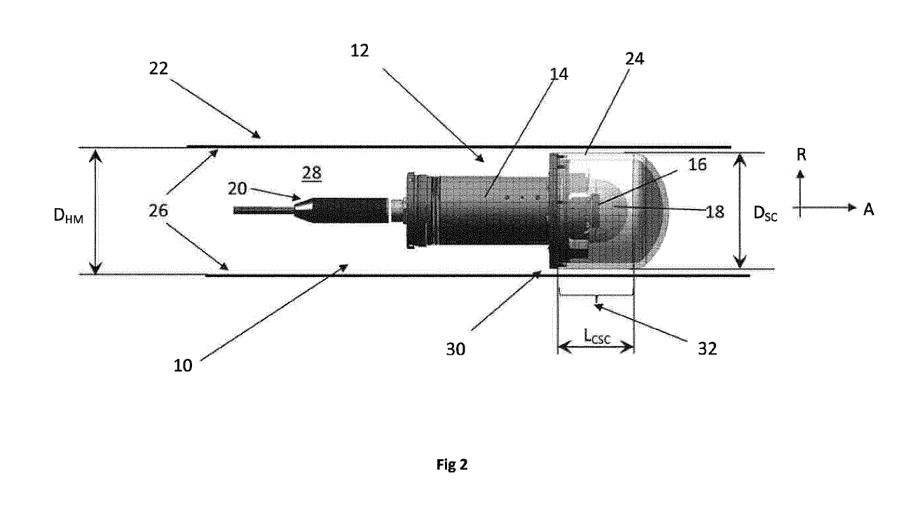

FIG. 2 illustrates one example of the present invention.

As such, FIG. 2 illustrates a sensor cover 24 for an inspection assembly 10. The inspection assembly 10 is adapted to inspect the interior of a hollow member 22.

The hollow member 22 could be any kind of hollow member that is adapted to be filled with an at least partially opaque fluid. Generally, the hollow member 22 could be a hollow member that is used in the oil and or gas industries. Purely by way of example, the hollow member may be a pipe for oil and/or gas drilling and/or production. Moreover, the hollow member 22 may form part of a valve system (not shown), such as a BOP (not shown) or a X-mas tree (not shown).

The hollow member 22 is at least partially filled with a hollow member fluid. The hollow member comprises a hollow member wall 26 defining a hollow member duct 28.

The sensor cover 24 comprises connection means 30 for connection to a sensor 12 of the inspection assembly 10 to so thereby cover at least a portion of the sensor 12. In the embodiment of the sensor cover illustrated in FIG. 2, the connection means 30 comprises a bolt joint adapted to be attached to a camera socket 14 such that the sensor cover 24 covers at least the a camera lens 16 and a the lens capsule 18 of the sensor 12. However, other embodiments of the sensor cover 24 may be adapted to cover more or fewer portions of the sensor 12.

As used herein the expression “connection to a sensor” encompasses any direct or indirect connection to the sensor. As such, embodiments of the sensor cover 24 may comprise connection means (not shown) that is adapted to be connected to a sensor via one or more intermediate connection members (not shown).

The sensor 12 is adapted to receive a sensor signal and the sensor cover 24 is adapted to transmit the sensor signal. In the embodiment illustrated in FIG. 2, the sensor 12 is a camera receiving optical signals. Consequently, the sensor cover 24 in FIG. 2 is adapted to transmit optical signals.

Purely by way of example, if the sensor is adapted to detect sound, the sensor cover 24 could for instance preferably be sufficiently acoustically transparent.

However, in other embodiments of the inspection assembly 10, the sensor may be adapted to receive another type of sensor signal. Purely by way of example, the sensor may be adapted to receive a sound signal, a microwave signal or an X-ray signal. In any one of the above examples, the sensor cover 24 should preferably be adapted to transmit the corresponding signal type. In other words, the sensor cover 24 should preferably be substantially transparent to the relevant sensor signal.

Moreover, the inspection assembly 10 could preferably comprise means for emitting the relevant sensor signal. As such, an embodiment of the inspection assembly may for instance comprise a sound signal emitting means, a microwave signal emitting means and/or an X-ray signal emitting means.

Regardless of which type of signal emitting means that may be used, the signal emitting means may preferably be adapted to emit a signal towards the hollow member wall and the sensor may be adapted to receive the signal that is reflected from the hollow member wall or is the result of the interaction between the emitted signal and the hollow member wall.

The sensor cover 24 is adapted to, at least during a sensor operation procedure, be accommodated in the hollow member 20.

The sensor cover 24 is adapted to operate as, or constitute, a hollow member fluid displacement means adapted to take the place of a portion of the hollow member fluid to thereby enable the sensor signal to be transmitted from the hollow member wall 26 to the sensor 12.

The sensor cover 24 may take the place of a portion of the hollow member fluid in a plurality of way. Purely by way of example, if an inspection assembly comprising the sensor cover is conducted through a hollow member, the sensor cover may displace a portion of the hollow member fluid. As another, non-limiting example, in a situation wherein the sensor cover is substantially stationary in a hollow member, the sensor cover may replace a portion of the hollow member fluid.

The above discussed hollow member fluid displacement and/or replacement function may be achieved in a plurality of ways. However, preferred embodiments are presented hereinbelow.

In a first embodiment, the hollow member 22 has a hollow member cross section area, i.e. an area of the cross section that is defined by the hollow member wall 26. The sensor cover 24 comprises a largest sensor cover cross section area. The largest sensor cover cross section area is at least 60%, preferably at least 80%, of the hollow member cross section area. In embodiments of the sensor cover 24, the largest sensor cover cross section area may even be at least 90% or even at least 95% of the hollow member cross section area.

The size of the largest sensor cover cross section area, in relation to the hollow member cross section area, that is required in order obtain appropriate signals from the hollow member wall to the sensor may be dependent on the signal opacity of the hollow member fluid.

Purely by way of example, if the sensor is a camera and the hollow member fluid is relatively transparent, a sensor cover with a relatively small largest sensor cover cross section area may suffice in order to obtain images of appropriate quality of the hollow member wall.

As another example, if the hollow member fluid is relatively opaque as regards the signal that the sensor is adapted to receive, a sensor cover with a relatively large largest sensor cover cross section area, resulting in a small gap between the sensor cover and the hollow member wall, should preferably be used in order to obtain appropriate results.

However, for at least some hollow member fluids, and for pipes having an outer diameter of seven inches or less, it may be appropriate to obtain a gap in the range of 10 to 30 mm, preferably 15 to 25 mm, between the sensor cover and the hollow member wall. Moreover, for at least some hollow member fluids, and for pipes having an outer diameter of more than seven inches, it may be appropriate to obtain a gap in the range of 10 to 100 mm, preferably 20 to 30 mm, between the sensor cover and the hollow member wall.

Moreover, for many types of hollow member fluid, the above discussed relative largest sensor cover cross section areas, for instance at least 60%, more preferred at least 80%, of the hollow member cross section area, will generally result in inspection assemblies that receive appropriate signals from the hollow member wall.

Furthermore, the largest sensor cover cross section area is preferably less than or equal to approximately 98% of the hollow member cross section area in order to facilitate that the sensor cover 24 can be displaced in relation to the hollow member. The possibility to displace the sensor cover 24 in relation to the hollow member may be further enhanced by providing the sensor cover with a dome shaped portion. The presence of the dome shaped portion implies that the risk that the sensor cover gets stuck in the hollow member is reduced as compared to a sensor cover with sharp edges.

Furthermore, the presence of the dome shaped portion may imply that an appropriate sensor signal transmission is achieved. Purely by way of example, if the sensor in an inspection assembly is a camera, the presence of a dome shaped portion of the sensor cover may facilitate the possibility to obtaining balanced images by the sensor.

In the embodiment illustrated in FIG. 2, the hollow member 22 has a substantially circular cross section with a hollow member inner diameter D_{HM} and at least the largest sensor cover cross section also has a substantially circular cross section with a sensor cover diameter D_{SC}.

In a preferred embodiment of the sensor cover 24, the sensor cover diameter D_{SC} is preferably at least 80%, preferably at least 90%, of the hollow member inner diameter D_{HM}.

Moreover, in a preferred embodiment of the sensor cover 24, the sensor cover diameter D_{SC} is preferably equal to or smaller than 99% of the hollow member inner diameter D_{HM}.

FIG. 2 further illustrates an embodiment of an inspection assembly 10 wherein the sensor cover 24 is adapted to be located outside the lens capsule 18 covering the camera lens 16. As such, in embodiments of the inspection assembly 10, the sensor cover 24 operates as a second sensor cover in addition to a first sensor cover, which first sensor cover is exemplified as the lens capsule 18 in FIG. 2. In the above discussed embodiment, the first sensor cover may have the advantage that it can reduce the risk that the sensor is impaired due to e.g. pressure differences that may occur between the sensor and the fluid ambient of the sensor cover-

Within the field of oil and gas drilling and production, hollow members with one of the following outer diameters are quite common: thirty inches, twenty-six inches, twenty inches, eighteen and three fourths inches, seventeen and a half inches, thirteen and three eights inch, twelve and one quarter inch, nine and five eights inch, eight and five eights inch, seven inches, five and a half inch as well as four and a half inch.

Expressed in millimeters, the above discussed outer diameters are: 762 mm, 660 mm, 508 mm, 476 mm, 445 mm, 340 mm, 311 mm, 244 mm, 219 mm, 178 mm, 140 mm and 114 mm.

As such, purely by way of example, an embodiment of a sensor cover may have cover diameter D_{SC} that is related to an inner diameter of a hollow member that has any one of the above discussed outer diameters of 762 mm, 660 mm, 508 mm, 476 mm, 445 mm, 340 mm, 311 mm, 244 mm, 219 mm, 178 mm, 140 mm and 114 mm.

Consequently, and again purely by way of example, a sensor cover may have a largest sensor cover cross section area that is at least 60%, preferably at least 80% of the inner cross section area of a hollow member with any one of the above discussed outer diameters. As another example, the largest sensor cover cross section area may be at least 90% or even at least 95% of the inner cross section area of a hollow member with any one of the above discussed outer diameters.

As another non-limiting example, an embodiment of a sensor cover may have cover diameter D_{SC} that is within the range of 80% to 99%, preferably within the range of 90% to 99%, of the internal diameter a hollow member with any one of the above discussed outer diameters.

As will be appreciated by a person skilled in the art, the inner diameter associated with each one of the above discussed outer diameters is dependent on the wall thickness of the hollow members.

However, representative inner diameters for each one of the above discussed outer diameters, expressed in millimeters, may be defined as: 724 mm, 627 mm, 481 mm, 448 mm, 418 mm, 315 mm, 283 mm, 220 mm, 196 mm, 154 mm, 120 mm and 98 mm.

As such, purely by way of example, an embodiment of a sensor so cover may have cover diameter D_{SC} that is related to any one of the discussed representative inner diameters of 724 mm, 627 mm, 481 mm, 448 mm, 418 mm, 315 mm, 283 mm, 220 mm, 196 mm, 154 mm, 120 mm and 98 mm.

Consequently, and again purely by way of example, a sensor cover may have a largest sensor cover cross section area that is at least 60%, preferably at least 80% of the inner cross section area of a hollow member with an internal diameter of 724 mm. As another example, the largest sensor cover cross section area may be at least 90% or even at least 95% of the inner cross section area of a hollow member with an internal diameter of 724 mm. Furthermore, the largest sensor cover cross section area may be less than or equal to approximately 98% of the inner cross section area of a hollow member with an so internal diameter of 724 mm.

As another non-limiting example, an embodiment of a sensor cover may have cover diameter D_{SC} that is within the range of 80% to 99%, preferably within the range of 90% to 99%, of the internal diameter of 724 mm of a hollow member.

Other non-limiting example embodiments of the sensor cover could for instance be obtained by using the above discussed ranges, be they related to the cross section area or the diameter of the hollow member, for at least one of the representative inner diameters: 724 mm, 627 mm, 481 mm, 448 mm, 418 mm, 315 mm, 283 mm, 220 mm, 196 mm, 154 mm, 120 mm and 98 mm.

Furthermore, FIG. 2 illustrates a preferred embodiment of the sensor cover 24 which comprises a cylindrical sensor cover portion 32 with a substantially circular cross section.

As may be gleaned from FIG. 2, the cylindrical sensor cover portion has a cylindrical sensor cover portion diameter D_{CS} in a radial direction R and an axial extension in an axial direction A. The axial direction A is substantially transversal to the radial direction R.

The cylindrical sensor cover portion has a cylindrical sensor cover portion length in the axial direction and the cylindrical sensor cover portion length L_{CSC} is at least 0.3 times, preferably at least 0.5 times, the cylindrical sensor cover portion diameter D_{SC}.

In this example, the probe is equipped with a transparent sensor cover, or dome, surrounding the camera lens attached to a dome fastening means on the camera socket. The dome should preferably be dimensioned to substantially fill the inner space of the pipe, but at the same time sufficiently small not to prevent free movements of the probe when running through the pipe.

The dome should preferably be made of a strong signal transparent material to be able to resist impacts and friction. Moreover, depending on the application, the dome could preferably also be adapted to resist high temperatures and/or high pressures. Purely by way of example, material of the dome may be an acrylic material or a sapphire crystal.

In the example illustrated in FIG. 2, the dome is filled with transparent fluid. The transparent fluid and the size of the dome adjusted to the inner dimension of the pipe provide a 180 degree line of sight from the camera lens to the objects or inner surface of the pipes to be inspected. The dome could also be filled with other transparent substances like transparent gas to provide the same effect.

However, if the sensor cover is adapted to be used in large water depths, a liquid filled dome may generally be preferred over a gas filled dome. This is since a liquid filled dome may be more susceptible to accommodating pressure changes around the sensor cover. Moreover, a liquid filled dome may have the advantage of providing a lower amount of buoyancy, as compared to a corresponding gas filled dome.

Instead of having hollow dome filled with a fluid, embodiments of the present invention may comprise a sensor cover, or dome, that is substantially compact.

By mounting a transparent substance filled dome outside the camera lens, tailor made for the specific inner diameter of the tubular, the distance and amount of particles between the lens and the tubular wall will be reduced. This mechanical removal of particles between the lens and tubular wall will increase the possibility to achieve quality images, with a 360 degree coverage around the inside of the tubular.

As being apparent from the discussion above, the present invention discloses an inspection systems providing 360 degree of continuous coverage within tubular environments filled with contaminated fluid, still keeping the installation to be inspected in the operational position.

The sensor cover according to the present invention may be manufactured and sold as a separate unit. Optionally, the sensor cover may for instance be manufactured and/or sold together with a sensor, either as a kit of separate components or as one component. It is also envisaged that a kit for an inspection assembly may be manufactured and sold which kit include at least one sensor and a plurality of sensor covers of different size.

Another aspect of the present invention relates to a method for forming an inspection assembly, which inspection assembly comprises a sensor and a sensor cover. According to the forming method, the size of the hollow member to be inspected is determined. A sensor cover is selected the shape of which is such that an appropriate amount of fluid in the hollow member will be replaced and/or displaced. Purely by way of example, the sensor cover may be selected such that an appropriate gap (for instance a gap within the previously discussed gap ranges of 10 to 30 mm, preferably 15 to 25 mm, for seven inch pipes or less or 10 to 100 mm, preferably 20 to 30 mm, for pipes having an outer diameter of more than 7 inches) is obtained between the sensor cover and the hollow member wall. As another non-limiting example, the sensor cover may be selected such that an appropriate area ratio is obtained between the sensor cover and the hollow member.

In a similar vein, a further aspect of the present invention relates to a method for inspecting a hollow member. According to the inspection method, the size of the hollow member to be inspected is determined. A sensor cover is selected the shape of which is such that an appropriate amount of fluid in the hollow member will be replaced and/or displaced. As for the method for forming an inspection assembly, the sensor cover may be selected so as to obtain preferred gap and/or a preferred area ratio.

The above discussed inspection method further comprises that the inspection assembly is arranged in the hollow member such that sensor signals may be transmitted from the hollow member wall to the sensor. Purely by way of example, the inspection assembly may be used in a static inspection procedure, e.g. the inspection assembly may be arranged so as to be stationary in relation to the hollow member in order to inspect for instance static characteristics and/or a dynamic phenomenon of a certain portion of a hollow member. As another non-limiting example, the inspection assembly may be used in a dynamic inspection procedure, e.g. the inspection assembly may be conducted in the hollow member, for instance by pulling the inspection assembly using the above discussed wire, in order to inspect a larger portion of the hollow member. It is also envisaged that an inspection method may comprise both static and dynamic inspection procedures.

As regards the above discussed forming method and inspection method, respectively, the desired sensor cover may for instance be selected from one of a plurality of existing sensor covers, for instance a plurality of sensor cover forming part of a kit for an inspection assembly. As another non-limiting example, the sensor cover may be selected by manufacturing a sensor cover the size of which is related to the size of the hollow member to be inspected.

The above description discloses different example embodiments for illustrative purposes. A person skilled in the art would realize a variety of sensor covers, kits and inspection assemblies within the scope of the appended claims.

1. A sensor cover for an inspection assembly, said inspection assembly being configured to inspect the interior of a hollow member, said hollow member being at least partially filled with a hollow member fluid, said hollow member comprising a hollow member wall defining a hollow member duct, said sensor cover comprising connection means for connection to a sensor of said inspection assembly to cover at least a portion of said sensor, said sensor being configured to receive a sensor signal and said sensor cover being configured to transmit said sensor signal;
said sensor cover being sized and configured to, at least during a sensor operation procedure, be accommodated in said hollow member; and
said sensor cover constituting a fluid displacement means configured to take the place of a portion of said hollow member fluid to enable said sensor signal to be transmitted from said hollow member wall to said sensor.

2. The sensor cover of claim 1, wherein said hollow member has a hollow member cross section area, said sensor cover comprising a largest sensor cover cross section area, said largest sensor cover cross section area being at least 60% of said hollow member cross section area.

3. The sensor cover of claim 1, wherein said sensor cover further comprises:
a sensor cover wall at least partially enclosing a sensor cover volume; and
a sensor cover fluid accommodated within said sensor cover volume.

4. The sensor cover of claim 3, wherein said sensor cover fluid is at least one of optically and acoustically transparent.

5. The sensor cover of claim 3, wherein said sensor cover fluid is a liquid.

6. The sensor cover of claim 1, wherein said sensor cover comprises a cylindrical sensor cover portion with a substantially circular cross section.

7. The sensor cover of claim 6, wherein said cylindrical sensor cover portion has a cylindrical sensor cover portion diameter and a cylindrical sensor cover portion length, said cylindrical sensor cover portion length being at least 0.3 times said cylindrical sensor cover portion diameter.

8. The sensor cover of claim 1, wherein a portion of the sensor cover is dome shaped.

9. The sensor cover of claim 1, wherein at least a portion of said sensor cover is made of one of an acrylic material and a sapphire crystal.

10. A kit for an inspection assembly for inspecting the interior of a hollow member, said kit comprising an inspection sensor and a sensor cover, said hollow member being at least partially filled with a hollow member fluid, said hollow member comprising a hollow member wall defining a hollow member duct, said sensor cover comprising connection means for connection to the inspection sensor of said inspection assembly to cover at least a portion of said inspection sensor, said inspection sensor being configured to receive the sensor signal and said sensor cover being configured to transmit said sensor signal;
said sensor cover being sized and configured to, at least during a sensor operation procedure, be accommodated in said hollow member; and
said sensor cover constituting a fluid displacement means configured to take the place of a portion of said hollow member fluid to enable said sensor signal to be transmitted from said hollow member wall to said inspection sensor.

11. The kit of claim 10, wherein said kit further comprises a plurality of sensor covers.

12. The kit of claim 11, wherein at least two of said sensor covers have different radial sizes.

13. An inspection assembly for inspecting the interior of a hollow member, said inspection assembly comprising an inspection sensor and a sensor cover, said hollow member being at least partially filled with a hollow member fluid, said hollow member comprising a hollow member wall defining a hollow member duct, said sensor cover comprising connection means for connection to the inspection sensor of said inspection assembly to cover at least a portion of said inspection sensor, said inspection sensor being configured to receive the sensor signal and said sensor cover being configured to transmit said sensor signal;
said sensor cover being sized and configured to, at least during a sensor operation procedure, be accommodated in said hollow member; and
said sensor cover constituting a fluid displacement means configured to take the place of a portion of said hollow member fluid to enable said sensor signal to be transmitted from said hollow member wall to said inspection sensor.

14. A method for forming an inspection assembly for inspecting the interior of a hollow member, said hollow member being at least partially filled with a hollow member fluid, said hollow member comprising a hollow member wall defining a hollow member duct, the method comprising:
determining a size of said hollow member duct;
determining an inspection sensor configured to receive a sensor signal,
determining an sensor cover configured to transmit said sensor signal, said sensor cover further being configured to cover at least a portion of said sensor, said sensor cover being configured to, at least during a sensor operation procedure, be accommodated in said hollow member, the size of the sensor cover being such that, during said sensor operation procedure, said sensor cover takes the place of a portion of said hollow member fluid to enable that said sensor signal to be transmitted from said hollow member wall to said sensor.

15. The method of claim 14, wherein said hollow member has a hollow member cross section area, said method further comprising:
selecting said sensor cover such that said sensor cover comprises a largest sensor cover cross section area, said largest sensor cover cross section area being at least 60% of said hollow member cross section area.

16. A method for inspecting the interior of a hollow member, said hollow member being at least partially filled with a hollow member fluid, said hollow member comprising a hollow member wall defining a hollow member duct, the method comprising:
determining a size of said hollow member duct;
selecting an inspection assembly the inspection assembly comprising an inspection sensor and a sensor cover such that said sensor cover at least partially covers said sensor, said sensor being configured to receive a sensor signal and said sensor cover being configured to transmit said sensor signal, said sensor cover being configured to, at least during a sensor operation procedure, be accommodated in said hollow member, the size of the sensor cover being such that, when said sensor cover is accommodated in said hollow member, said sensor cover takes the place of a portion of said hollow member fluid to enable said sensor signal to be transmitted from said hollow member wall to said sensor; and
arranging said inspection assembly into said hollow member.

17. The method of claim 16, further comprising forming an inspection assembly by connecting together said inspection sensor and said sensor cover such that said sensor cover at least partially covers said sensor.

18. The method of claim 16, wherein said hollow member has a hollow member cross section area;
said method further comprising selecting said sensor cover such that said sensor cover comprises a largest sensor cover cross section area, said largest sensor cover cross section area being at least 60% of said hollow member cross section area.

19. The sensor cover of claim 2, wherein said sensor cover further comprises:
a sensor cover wall at least partially enclosing a sensor cover volume; and
a sensor cover fluid accommodated within said sensor cover volume

20. The sensor cover of claim 4, wherein said sensor cover fluid is a liquid.
